(19) United States
(12) Patent Application Publication
(10) Pub. No.: US 2009/0192808 A1
(43) Pub. Date: Jul. 30, 2009

(54) Method and Device for Providing a Personal Product Recommendation

(75) Inventor: Mor Sela, Chestnut Ridge, NY (US)

Correspondence Address: Law Office of Michael J. Feigin, 103 The Circle, Passaic, Passaic, NJ, 07055, US

(73) Assignee: ProCompare, LLC

(21) Appl. No.: 12/020,653

(22) Filed: Jan. 28, 2008

(51) Int. Cl. G06Q 99/00; G06F 17/10

(52) U.S. Cl. 705/1

(57) ABSTRACT

The invention disclosed provides a device and method for recommending at least a product or a plurality of products to a user based at least in part on opinion-based criteria. The invention proceeds by first choosing a plurality of products in a category. At least one product in the category is associated with at least one rating. The rating comprises a rating of a plurality of criteria, and the plurality of criteria comprises opinion-based criteria. In the next step of the method of the invention, a calculation of product recommendability of the plurality of products is made (caused to be made) based on a selection by at least one user of an importance level of a plurality of criteria. Then at least one product recommendation is provided (received) based on the selection by at least one user of an importance level of a plurality of criteria and the opinion-based criteria.

### BACKGROUND OF THE INVENTION

When a consumer desires to make a purchase, he or she is faced with a plethora of choices as to which product or service to buy. There are many methods known in the art to aid in making a decision but the methods known in the art to make such a decision each have their own set of advantages and disadvantages. Factored into the decision as to which of the plethora of products on the market to purchase will be certain functionality characteristics such as the physical characteristics or capabilities of the product including the price, brand, physical attributes (size, weight, portability, etc.), capabilities (camera zoom, car power steering, Bluetooth connectivity, etc), and price of purchase. To reach an informed conclusion, the purchaser may read product labels and professional product reviews, access vendor websites, and listen to the opinions of friends and consultants, but each method is not without its shortcomings.

First, reviewing product labels and the like is time-consuming. There is a huge amount of products to review, prices vary from retailer to retailer, sources of information may be biased, and resources of the consumer may be limited or it may not be justified for the consumer to spend the time needed to make the most informed decision. In addition, it is hard to garner from such information whether the product is the one that best suits the purchaser's requirements.

One can consult a magazine for product reviews, but the number of products reviewed is limited by the magazine staff and the amount of space available to a given article. Often, an entire category to be reviewed is dealt with by a single person or a small group of people. The reviewer (or reviewers) chooses which features to focus on, and even if he or she is very competent in the field being reviewed, there will still be an inherent personal bias with regard to the method of review, product selection, etc.

Decision-making may be facilitated by a personal recommendation from a person who has experience with the desired type of product, such as an IT consultant. However, obtaining such assistance is often expensive and not always possible. It is also difficult to hone in on exactly what questions should be put to the experienced person and nearly impossible for this person to have state-of-the-art knowledge of price fluctuations, new features, and so forth of hundreds or thousands of products on the market.

Some of the above limitations have been reduced in recent years with the rapid development of e-commerce and online shopping. For example, selection of a product by an automated or semi-automated filtering process is known in the art, where a user can select a category as well as a set of specific desired features. One common example of a filtering process is found on retailer websites such as Shopping.com, Newegg.com, and the like. This method includes specifying a category of products, followed by filtering based on functional features or ranges of features of products. For example, a user may select laptop computers and then narrow the range of selection by selecting a range of prices and range of processor speeds.

Such methods are mechanical, and lack human input with regards to providing a recommendation based on the narrowed selection. Still further, the top recommended products may be based upon an incentive for the seller or vendor and not the consumer. For example, the best placement of products within each category may be paid for by a manufacturer or may yield the highest profit for the vendor. When reviews of one of the products uncovered can be read in conjunction with the filtering process, such reviews are typically by prior purchasers, where the quality and bias of the reviewers are unknown. The reviews may also be submitting reviews on behalf of the manufacturers.

Another such example of filtering products has been disclosed in U.S. Pat. No. 6,236,900 and assigned to Intraware, Inc. This reference teaches a system and method for selecting a product from multiple products grouped into categories. While this reference takes into account the desires of the user with regard to the functional aspects of a product to be purchased by a user, the product selection is again limited to a mechanical approach to product selection, because it is inherently based only on the functional characteristics of the products.

Other methods known in the art allow for a less rigid approach to filtering products by making it possible for a user to select various functional criteria for the product and an importance level of some of these criteria. While this allows for certain functional criteria to be given greater weight than others by using Bayesian analysis and other techniques, the product selection is still inherently mechanical. The choices are still those of functional characteristics of the product, without taking into account factors which an IT consultant or other expert could provide.

Thus, the above methods only partially solve the problem for a user who seeks to purchase a specific product. Automated means of providing recommendations known in the art evaluate the functionality of products. Personal recommendations of products tend be filled with biases of the recommender and are limited in scope to the knowledge of the recommender. While prior art methods provide the ability to find products with specific functional specifications or to find products based on a personal recommendation, there remains an unsatisfied and long felt need to provide to a user the product or products best suited to his or her preferences, even when the user does not know what questions to ask, and in a manner which decreases the biases and limitations taught in the prior art.

### SUMMARY OF THE INVENTION

It is therefore an object of the present invention to provide a method and device capable of sorting through a large number of products in a category and provide a product recommendation to a user which incorporates importance level of a plurality of criteria, including opinion-based criteria.

It is a further object of the invention to provide a product recommendation based on a plurality of expert reviews and/or to use criteria to weight experts or reviews so as to decrease reviewer bias.

The method of the invention proceeds by first choosing a plurality of products in a category. The choosing may be accomplished by a user and/or by a device capable of receiving a selection of a category from a user. At least one product in the category is associated with at least one rating. The rating comprises a rating of a plurality of criteria, and the plurality of criteria comprises opinion-based criteria. Opinion-based criteria are those related to the product which are dependent upon an evaluation by an expert or a user, and which are capable of receiving substantially different ratings by different users, and/or require the judgment of an expert or user of the product. In the next step of the method of the invention, a calculation of product recommendability of the plurality of products is made based on a selection by at least one user of an importance level of a plurality of criteria. Then at least one product recommendation is provided based on the selection by at least one user of an importance level of a plurality of criteria and the opinion-based criteria.

The criteria may further comprise functionality-based criteria of the product. The at least one rating may be a plurality of ratings and at least some of the plurality of ratings may be provided by at least one expert.

The plurality of criteria may comprise a plurality of sub-criteria. The sub-criteria may comprise at least a first sub-criterion with a first weighting and at least a second sub-criterion with a second weighting.

The at least one product recommendation to a user may be provided based on an average selection of importance level by a plurality of users, or the selection by at least one user is a selection by a user and the product recommendation is provided to the user making the selection. A product review by an expert may be provided to a user along with a product recommendation.

The step of calculating may be performed using a predefined algorithm. The choice of a plurality of products may be limited by further criteria provided by a user. The opinion-based criteria may include cost of operation/ownership.

The device of the invention provides a recommendation of at least one product. The device is configured to store information related to a plurality of products in a category, wherein at least one product is associated with at least one rating. The rating comprises a rating of a plurality of criteria and the plurality of criteria comprises opinion-based criteria as defined with regard to the method of the invention. The device then calculates product recommendability of the plurality of products based on a selection by at least one user of an importance level of a plurality of criteria and provides at least one product recommendation to a user based on the selection and the opinion-based criteria. The device may also carry out the further steps of similar to the manner in which are described with regard to the method of the invention.

### BRIEF DESCRIPTION OF THE DRAWINGS

FIG. 1 is a flowchart of a method of recommending a product based on a selection of importance of opinion-based criteria in an embodiment of the invention.

FIG. 2 is a flowchart of a method of rating a product using opinion-based criteria in an embodiment of the invention.

FIG. 3 is a flowchart of a method of rating criteria and sub-criteria of a product in an embodiment of the invention.

FIG. 4 is an example of a screenshot of a plurality of product recommendations returned to a user in an embodiment of the invention.

FIG. 5 shows a high-level block diagram of a distributed device that may be used to carry out the invention.

FIG. 6 is a high level block diagram of a device that may be used to carry out the invention.

### DETAILED DESCRIPTION

The invention disclosed provides a device and method for recommending at least a product or a plurality of products to a user based at least in part on opinion-based criteria. A product may be any device, service, piece of software, and so forth, available for purchase to a person using a device or method of the invention. In embodiments of the invention, ratings are provided by experts. An expert is considered a person who would be given such a designation by a person reasonably skilled in the art of the product being rated or has a certification from a recognized institution. With regard to consumer electronic devices, such users may be experts, or people who have purchased the product they are rating and have familiarity with the product. In embodiments of the invention, a rating may be submitted by a user who wishes to share his/her knowledge. A method of qualifying an expert before allowing the expert to rate a product may be employed, such as by requesting completion of a questionnaire and verifying that the expert is knowledgeable with regard to the product to be rated. Such tests may be used to weight the expert reviews of the product.

In embodiments of the invention, the ratings of the various criteria and sub-criteria, the weight given to each review, and the importance level of various criteria as selected by a user receiving a recommendation are calculated by any reasonable method known in the art to provide at least one product recommendation to the user.

The rating comprises a rating of a plurality of criteria, the plurality of criteria comprising in whole or in part opinion-based-criteria as will be described herein below with respect to the figures. Functionality criteria about the product may also be provided by the expert or user submitting the rating, or may be provided in advance such as by a vendor, with a prior rating, or entered separately.

The scope of the invention will become clearer with reference to the figures as described herein below.

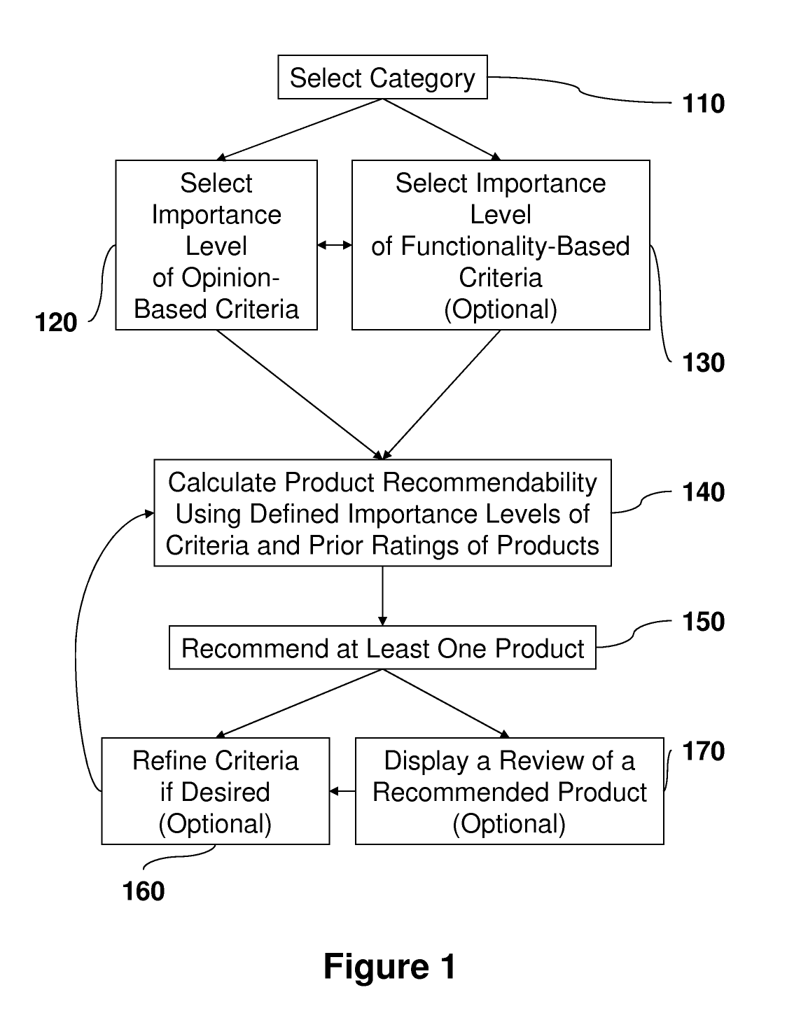

FIG. 1 is a flowchart of a method of recommending a product based on a selection of importance of opinion-based criteria in an embodiment of the invention. In an embodiment of the invention, in step 110, the method of the invention proceeds when a user, such as a person who desires to search for or purchase a product, selects a category. The category comprises a plurality of products or is associated with a plurality of products. A product may be in one or more category, and at least one product in the category is associated with at least one rating. In one embodiment of the invention, the user selecting a category in step 110 and ultimately receiving a product recommendation in step 150 is the same user, but in a second embodiment, are different users. Still further, the user selecting a category in step 110 or receiving a product recommendation may or may not have previously provided a product recommendation for at least one product within the selected category.

In step 120, the user (anyone who makes the selection or wishes to receive a product recommendation) selects an importance level of opinion-based criteria. In step 130, the user may optionally select an importance level of functionality-based criteria. Steps 120 and 130 may occur in any order, may be carried out again in any order or individually, and may be repeated multiple times. For example, a user may find a certain opinion-based criterion to be of high importance and a certain functionality-based criterion to be of low importance. The importance level may be assigned a number to assist in a calculation of recommendability and may be on a scale from one to ten, inclusive; using whole numbers only; a linear scale; a logarithmic scale; or the like. The opinion-based criteria used in step 120 and the functionality-based criteria used in step 130 may be any criteria entered by an expert or user in the rating process, predefined for use with the method (or device) of the invention, or the like. Thus, a user may separately or interchangeably be provided with criteria from which he or she chooses an importance level. The choosing may be accomplished by a user and/or by a device capable of receiving a selection of a category from a user.

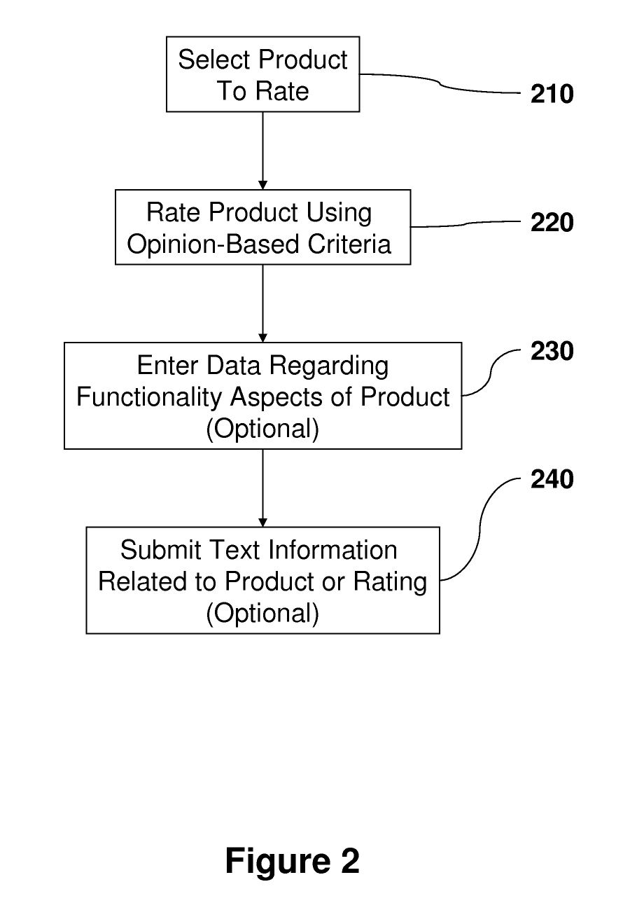

Functionality-based criteria, as used in the disclosure of this invention and as in step 130 of FIG. 2, are defined as non-judgmental criteria related to a particular product offered for purchase or usage by the user. Such criteria for an individual product stay substantially the same, or the same for each product purchased, sold, or used. Substantially the same, in the context of functionality criteria, means within a level tolerated by the marketplace or in accordance with industry standards (i.e., processor speed among different embodiments of the same product may vary within a few megahertz, price for purchase may vary in accordance with what a reasonable retailer would charge in the marketplace, and so forth). For example, where the product is a laptop computer, functionality criteria might include the physical dimensions, weight, advertised battery life, processor speed, price, Bluetooth capability, maximum screen resolution, and so forth.

Opinion-based criteria, as used in the disclosure of this invention and as in step 120 of FIG. 2, are criteria related to the product which are dependent upon an evaluation by an expert or a user, are ordinarily capable of receiving substantially different ratings or values by different experts or users, and/or require the judgment of an expert or user of the product. In this context, substantially different means that when rated by a plurality of users it is within reason for each user to rate an opinion-based criterion differently (outside a statistically calculated margin of error) than another user. For example, opinion-based criteria may include overall satisfaction with the product; satisfaction with technical support; ease of use; ease of use in comparison to other products in the category; ease of installation or implementation; whether the price is justified, given a quality or functionality characteristic of the product; an opinion of worksmanship with regard to the product; estimated cost of operation over time for the product; and so forth.

Cost of operation of a product may be a functionality-based criterion when the calculation consists of known or defined sub-criteria (i.e, setting a cost of electricity to power the device, a number of hours the device will be powered up over a time period, and so forth). However, when cost of operation of a product is an opinion-based criterion, at least a portion of the sub-criteria is defined by the user or expert submitting the rating. For example, an expert may submit a rating for a product which comprises a rating of cost of operation of a cellular phone. A manufacturer may calculate that a battery replacement will be required every three years at a cost of $30, based on known or defined sub-criteria. However, when an expert submits the rating for purposes of recommending a product, the expert may base his/her opinion on predefined sub-criteria (i.e., by selecting an estimated battery life), entering his/her own sub-criteria (i.e., considering environmental disposal cost of lead in the phone), or using at least one intangible sub-criterion or criterion (i.e., his/her estimate of how long the battery will last or how much the phone will cost to operate). Each criterion or sub-criterion may be weighted differently, as will be explained below with regard to the calculations involved.

Referring again to step 120, in one embodiment of the invention a user may select only opinion-based criteria and avoid step 130 related to functionality-based criteria. For example, if the category selected in step 110 was GPS devices, then the criterion selected might be quality of product and quality of technical support, and the user may indicate that both such criteria are important. However, the user may also enter functionality criteria in step 120. Thus, the user may require that the GPS device in the prior example have speech recognition capability. Then, continuing in this example, the user may again select an importance level of opinion-based criteria, such as ease of setup of the speech recognition capability.

In step 140, based on at least one opinion-based criterion, importance level selected by the user, and category of the products and the ratings provided, a calculation is made of product recommendability. A calculation of product recommendability as used in the invention means that either a person or device makes the calculation of product recommendability or inputs or provides data which causes such a calculation to be made. In an embodiment of the invention, each product receives a product score which may be displayed to the user and/or used to aid in a calculation of product recommendability. Algorithms which may be used in embodiments of the invention to carry out steps of the method of the invention or which may be calculated in conjunction with a device used in the invention are shown in Table 1 below.

TABLE 1
Product Score = (C1BW * C1WAR + C2BW * C2WAR + ... + CnBW *
CnWAR) / SUM (C1BW; CnBW)
CxWAR = (E1RCx * E1TR + E2RCx * E2TR + ... + EnRCx * EnTR) /
SUM (E1TR; EnTR)
ExRCx = (ExRCx.1 * Cx.1AW + ExRCx.2 * Cx.2AW + ... + ExRCx.n *
Cx.nAW) / SUM (C1AW; CnAW)

The calculation of product score is explained as follows. Cx is Criterion x and is defined as one of the Selection Criteria (i.e., C1 may be Performance, C2 may be Ease of Use, C3 may be Reliability, etc.). Cx·y is Sub-Criterion x·y and represents sub-criteria that affect a certain criterion (i.e., sub-criteria of ease of use may be volume control). CxBW is a measure of a user (or “buyer” or “purchaser”) weighting for Criterion x and may be a numeric value that indicates the user-preferred (a selected or default) weight for Criterion x (i.e., if the user selected that reliability is the most important criterion, CxBW may be set at ten on a scale from 1 to 10).

The calculated values may be further modified based on other factors. Cx·yAW is a predefined weighting for sub-criterion x·y. (e.g., an administrator-defined value. For example, when rating ease of use, volume control weight may account for 20% of the ease-of-use criterion and keyboard weight accounts for 30% of ease of use). CxWAR may also be predefined and is a weight of a specific criterion which may vary between a first criterion, second criterion, and so forth. It is a weighted average rating of criterion x (for a specific product).

Further definitions for terms in Table 1 include: Ex, for expert x, an expert or user providing a product rating; ExRCx, a measure of expert x's rating of Criterion x (for a specific product); ExTR, a measure of the experts rating multiplied by a weighting given to the rating, such as is described below with reference to FIG. 2.

Referring again to FIG. 1, in step 140, after using any of the above algorithms to calculate product recommendability, or calculating product recommendability by other means known in the art or contemplated as being within the scope and spirit of the invention, i.e., removing outlying reviews or importance levels, only considering high importance levels, and so forth, at least one product is provided to a user in the form of a recommendation. The step of providing means that either a user causes a recommendation to be provided or that a device exhibits or displays at least one recommended product to a user. The product recommendation may be based upon a product having the highest score. If multiple products are recommended, the products having the highest scores may be displayed or otherwise presented or exhibited to a user.

In the method of the invention, optional steps 160 and 170 are carried out in some embodiments of the invention. If step 170 is carried out, it is typically carried out before step 160. In step 170, a display of a review provided by a user or expert who rated a recommended product of step 150 is displayed, exhibited, or otherwise provided to the user receiving the recommendation.

In step 160, the receiving user (i.e., the user receiving the recommendation or the “buyer”) may refine criteria of the products to be recommended. This may be as simple as selecting a “remove” button, or indicating a dislike of a product wherein the product will no longer be recommended. Or, the user may enter further opinion-based or functionality-based criteria, such as requiring that recommended products have a certain feature, have received a certain number of ratings, have been rated higher or lower in a specific area, and the like. In step 160, the user may decide to refine a product based on an importance level of a sub-criterion. After step 160 is complete, if need be, such as where the refinement requires a further calculation, step 140 is carried out again and a new set of products (or fewer products) is recommended, based on the refined criteria. It is also contemplated and within the scope and spirit of the invention for step 160 to occur at any time before step 150 when a product is recommended, such as before or after step 110 or before or after step 140.

FIG. 2 is a flowchart of a method of rating a product using opinion-based criteria in an embodiment of the invention. In step 210, a user or expert as defined above selects a product to rate. (While the figure will be described in terms of an expert rating the product, it should be understood that in embodiments of the invention, an expert, user, or any person with specific knowledge with regards to a product may rate a product.) In step 220, the expert will then rate the product based on a plurality of opinion-based criteria. In an embodiment of the invention, an expert is provided with a slider on a computer screen to adjust for various opinion-based criteria. Any method for receiving an expert rating known in the art may be used, such as allowing or receiving entry of a number representative of a rating value for an opinion-based criterion. For example, an expert who is rating a product in step 220 may be presented with various opinion-based criteria to be rated, such as rating ease of use, technical support, product reliability, product working as advertised, estimated actual cost of operation, and so forth. Other information may also be garnered; such information may relate to an expert's familiarity with a product, length of use, attempt to use various features of the product, and prior experience with the specific type of product being rated. Such information may be used to assign a weighting to the expert's rating.

In step 230, an optional step of entering data regarding the functionality aspects of the product being rated is carried out in some embodiments of the invention. This step may take place, for example, when products are being rated in an online environment, and the expert is the first to rate a product or is correcting an error related to a previously entered product. Where product information is predefined or provided before expert ratings take place, step 230 will be skipped.

In step 240, text information may be submitted which relates to the product or the rating itself. The text information may include a review of the product by the expert rating the product or other information which may be used by administrators or users receiving product recommendations. For example, an expert rating a product may submit a review of the product, a list of pros or cons concerning the product, elaborate on his/her knowledge of the product and/or on why the product was rated in such a manner, request administrators to keep his/her review private, explain why certain requested criteria were inapplicable, or submit other comments about the process itself.

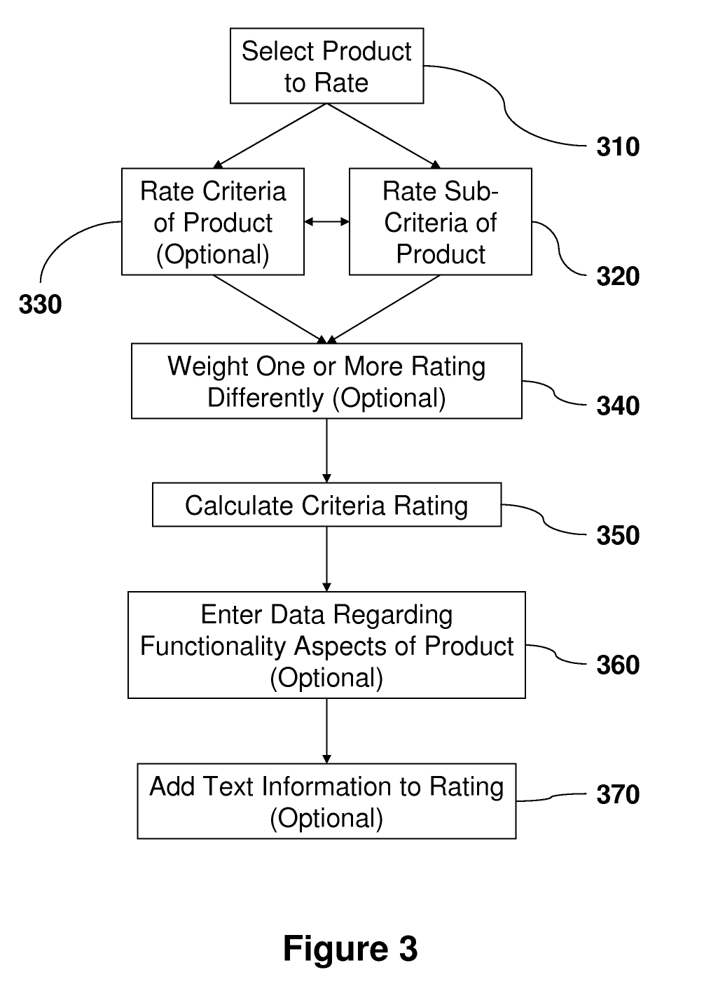

FIG. 3 is a flowchart of a method of rating criteria and sub-criteria of a product in an embodiment of the invention. In step 310, similar to step 210 of FIG. 2, an expert rates a product. In step 320, sub-criteria of a product are rated. At least two sub-criteria with individual ratings when calculated together, or with a rating of the criteria itself, make up a rating of a criterion of a product. Step 320 may be carried out multiple times for rating various sub-criteria, and step 330, the rating of criteria of a product, may be carried out at least once with regard to each criterion rated with sub-criteria. Further, step 330, the rating of criteria of a product, may be carried out multiple times and at least some criteria may be rated without the rating of sub-criteria. Steps 320 and 330 may take place concurrently, in any order, and/or be repeated in any order depending on the specific embodiment. It may be desired to have step 320 take place before step 330 or step 330 to take place before step 320.

For example, when selecting a specific piece of accounting software in step 310, a criterion to be rated may be functionality of the software. In step 320, the expert may rate various sub-criteria, such as rating reporting, rating data entry, rating product documentation, and so forth. Sub-criteria of the sub-criteria may also be rated, such as rating an account receivable and account payable report within the rating of reporting. In addition, in step 330, the expert may rate the general criteria of ease of use. The same rating method would be applied to each criterion to be rated.

In step 340, a weighting may assigned to each sub-criterion. Step 340 may occur before the ratings of the sub-criteria, be predefined, or occur in conjunction with step 350. Step 340 may also comprise a weighting of the criteria rated in step 330. Step 340 may also include rating sub-criteria and/or criteria in a different manner, depending on whether the expert submitted a rating for each criterion or sub-criterion.

Again using a piece of accounting software selected in step 310 as an example, a user may have submitted ratings on the ease-of-use criterion by submitting (or being prompted to submit) only ratings of sub-criteria. These sub-criteria, again, may include ratings of ease of use of reporting, product documentation, and data entry. Each sub-criterion may be given an equal weighting or be rated differently. Thus, each sub-criterion may contribute to ⅓ of the weighting of the criteria, a ½, ¼, ¼ rating respectively, or any other weighting. If a certain sub-criterion is not rated by the expert, then a different weighting may be assigned to the rated sub-criteria, criteria, or overall expert rating. Similarly, if the expert is, in addition, asked to rate the criterion itself, i.e., ease of use, then the weighting may again vary. For example, an ease-of-use criterion may be rated as ¼ and each sub-criterion contribute to the rating in equal shares of the remainder, or, again, be weighted differently. Still further, variations in weighting may occur if either a sub-criterion or criterion is not rated.

Then, in step 350, a criteria-rating is calculated based on the ratings and weightings. In step 360, an expert rating the product may enter data regarding the functionality aspects of the product similar to step 230 of FIG. 2. In step 370, text information related to the rating may be added similar to step 240 of FIG. 2.

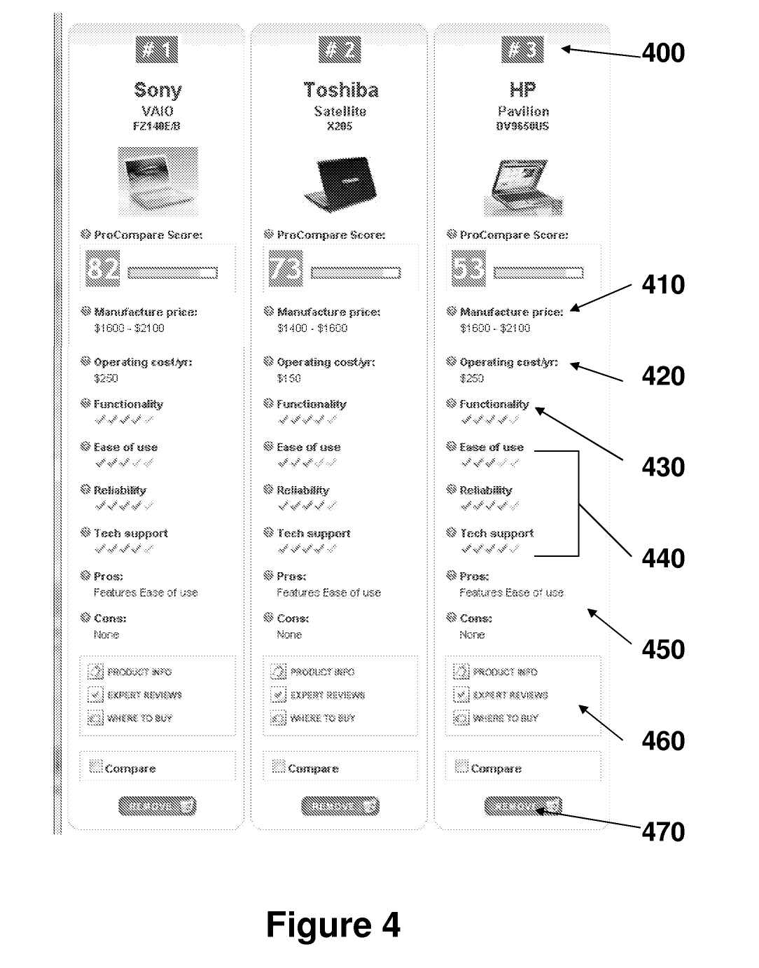

FIG. 4 is a screenshot of a plurality of product recommendations returned to a user in an embodiment of the invention. In this screenshot, three products 400 with labels, “#1”, “#2”, and “#3” have been recommended to a user based on a category and importance level selected. While any reasonable product information may be displayed to the user, in this example product information, a picture, and a score are provided for each product recommended, in addition to further information which will be described below in greater detail.

Manufacturer price 410 is the price or price range at which the manufacturer lists the product for sale or expects the product to be sold by a retailer. The manufacturer price 410 may also be received from at least one vendor. The operating cost/yr 420 may be a functionality- or opinion-based criterion as described above. Functionality 430 may also be a functionality- or opinion-based criterion depending on the embodiment of the invention. Functionality 430 may be a rating of a number of features available in comparison to other products within the same category, and thus be a functionality-based criterion, or may be calculated based on the opinions provided by experts and be an opinion-based criterion. Ease of use, reliability, and tech support criteria 440 are opinion-based criteria calculated based on ratings provided by experts, and may further be calculated based on a user rating of an importance level of each criterion. In embodiments of the invention where users can select an importance level of sub-criteria, the calculation of criterion 440 may additionally be based upon such a selection.

Pros and cons 450 may be entered manually, received from a vendor, or entered by an expert when rating a product. The pros and cons 450, which are listed with regard to a specific product, may be chosen based on those pros and cons which are most selected by experts when rating the product, or those chosen by a single expert who rated the product. When displaying or otherwise exhibiting pros and cons 450 entered or selected by an expert, the decision as to which expert or expert's rating to choose may be based on a manual designation or automatically distinguished based on criteria. In an embodiment of the invention, the pros and cons 450 may be generated by selecting the most positive and negatively rated criteria for a product such as by displaying as a “pro” a criteria rated within a top percentage such as the top 15% compared to ratings of similar products. Likewise, this method may be used to display as a “con” a criteria rated within a bottom percentage such as the bottom 15% compared to ratings of similar products.

Options 460 allow a user to take further actions. Some further actions listed in FIG. 4 allow a person to view product information, view one expert review or several, and/or find out where to purchase or evaluate the product. Remove button 470 allows a user to remove the product from the list of products recommended to the user. Clicking the remove button 470 may cause the product to be removed from a display of recommended products and/or may cause a provided list of recommended products to be recalculated. The recalculation may result in a recommendation of a product not previously recommended, or change a calculation and/or provided result of an opinion-based criterion. If the remove button 470 causes a new product to be displayed, in embodiments of the invention, a product (or product information) will be provided which was calculated to be the next best recommended product after those already provided. When the opinion-based criteria are re-calculated in embodiments of the invention, this is because calculations of the opinion-based criteria, or at least a part of the display of same to a user receiving a recommendation, are relative to ratings received by other recommended products or products within a selected category.

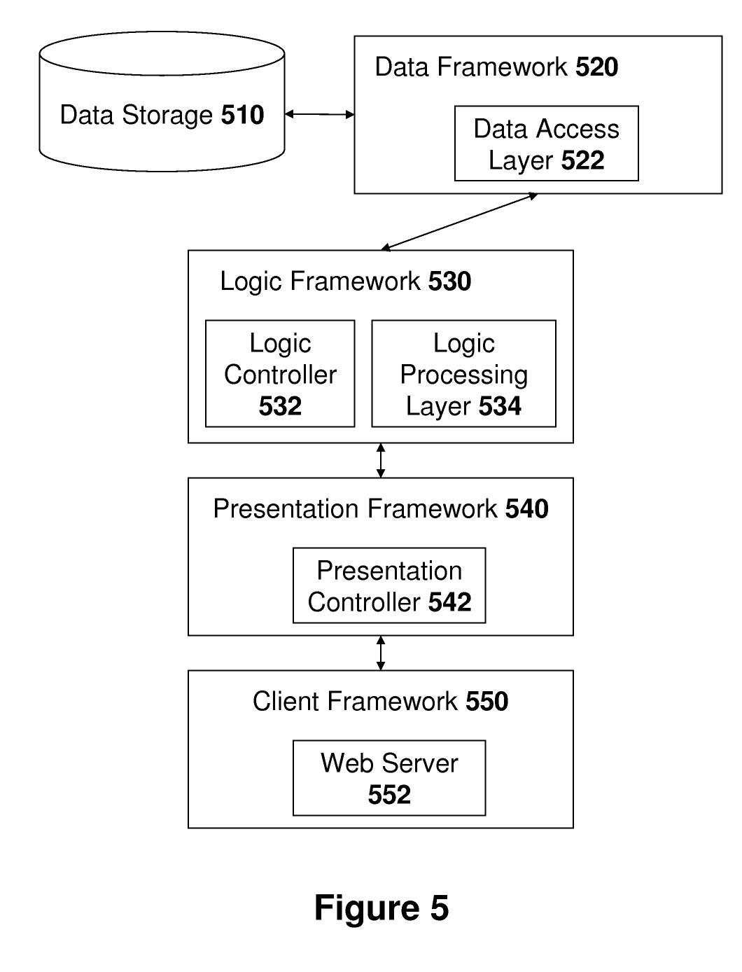

FIG. 5 shows a high-level block diagram of a distributed device that may be used to carry out the invention. Data storage 510 may be any storage device known in the art including a magnetic or optical disk. Data framework 520 handles the flow of data from data storage 510 to logic framework 530. The data framework 520 comprises at least a data access layer 522 for accessing the date storage 510 and putting data into a database accessible by the logic framework 530. Logic framework 530 conducts mathematical functions and calculations as used in the invention such as calculating product recommendability and receiving and calculating ratings. The logic framework 530 comprises at least a logic controller 532 to receive and send instructions to handle logic functions as well as a logic processing layer 534 to handle the processing of instructions and logic functions. The results may be send to the data framework 520 for entry into a database or sent to presentation framework 540 for exhibiting in a form viewable by a user. Presentation controller 542 is situated within the presentation framework and controls the presentation of data and may control interaction with the logic framework 530 and the client framework 550. The client framework 550 comprises a web server 552 for sending a website to a user for display and interacts with the presentation framework 540 to receive and send data. Each of the overall elements (510, 520, 530, 540, and 550) may exist within a single or multiple computing devices and may interact may any reasonable means known in the art including via a network, data pathways within a computing device, and so forth. The device shown in FIG. 5 may be used to carry out the method of the invention as shown in the proceeding figures.

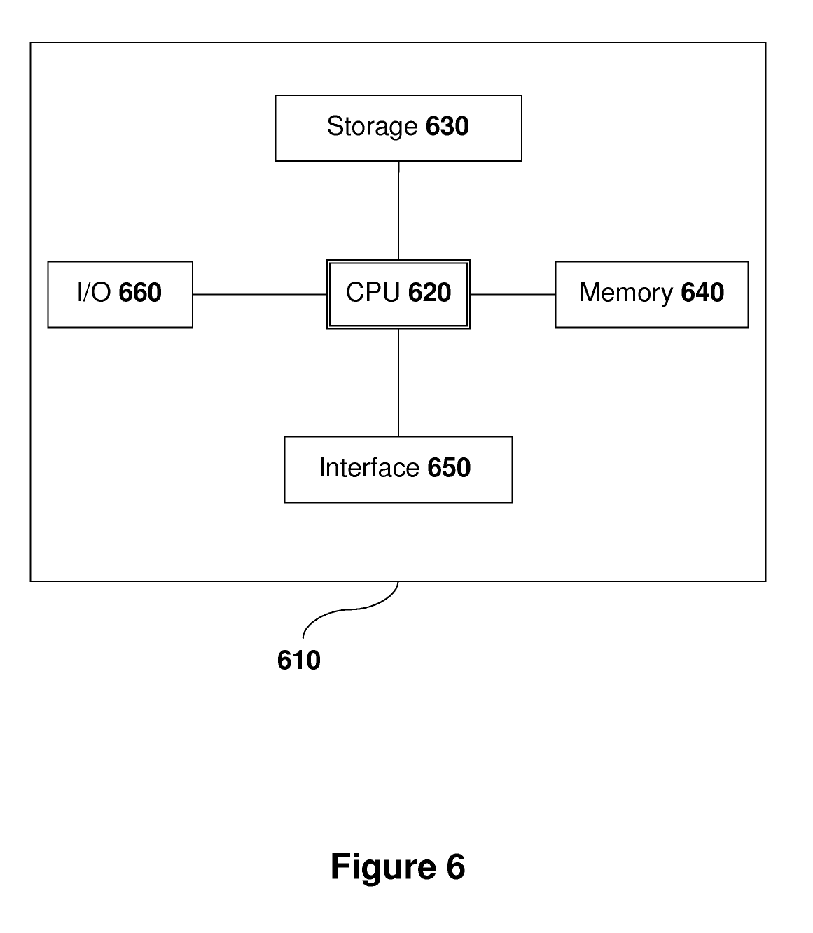

FIG. 6 shows a high-level block diagram of a device that may be used to carry out the invention. The device 610 comprises a CPU (processor) 620 that controls the overall operation of the computer by executing computer program instructions which define such operation. The computer program instructions may be stored on a storage device 630 (e.g., magnetic disk, database) and loaded into memory 640 when execution of the computer program instructions is desired. The storage device 630 may be used in embodiments of the invention to store information related to a plurality of products' data as well as ratings, reviews, algorithms, and so forth. Thus, the computer operation will be defined by computer program instructions stored in memory 640 and/or storage 630, and the computer will be controlled by CPU 620 executing the computer program instructions. Device 610 may also comprise one, or a plurality of, input or output interfaces 660, such as network interfaces for communicating with other devices via a network (e.g., the Internet) and input/output 660 representing device which allow for user interaction with the device 610 (e.g., display, keyboard, mouse, speakers, buttons, etc.). Calculations used in the method of the invention may be carried out on such a device. One skilled in the art will recognize that an implementation of an actual computer will contain other components as well such as a distributed device or network device wherein the components reside on separate computing devices, and that FIG. 6 is a high level representation of some of the components of such a computer for illustrative purposes. It should also be understood by one skilled in the art that the method and devices depicted in the previous figures may be implemented on a device such as is shown in FIG. 6.

While the invention has been taught with specific reference to the above embodiments, a person having ordinary skill in the art will recognize that changes can be made in form and detail without departing from the spirit and the scope of the invention. The described embodiments are to be considered in all respects only as illustrative and not restrictive. All changes within the meaning and range of equivalency of the claims are to be embraced within their scope.

I claim:

1. A method of providing a recommendation of at least one product, said method comprising the steps of:
choosing a category comprising a plurality of products, wherein at least one product is associated with at least one rating, and said rating comprises a rating of a plurality of criteria, and said plurality of criteria comprises opinion-based criteria;
calculating product recommendability of said plurality of products based on a selection by at least one user of an importance level of a plurality of criteria; and
providing at least one product recommendation of a product in said category based on said selection and said opinion-based criteria.

2. The method of claim 1, wherein said criteria further comprise functionality-based criteria of said product.

3. The method of claim 1, wherein said at least one rating comprises a plurality of ratings and each rating of said plurality of ratings is provided by an expert.

4. The method of claim 1, wherein said plurality of criteria comprises a plurality of sub-criteria.

5. The method of claim 4, wherein said sub-criteria comprise at least a first sub-criterion with a first weighting and at least a second sub-criterion with a second-weighting.

6. The method of claim 1, wherein said selection by said at least one user comprises a selection by a plurality of users and said step of calculating product recommendability is based on an average selection of said plurality of users.

7. The method of claim 1, wherein said selection by at least one user is a selection by one user and said product recommendation is provided to said one user.

8. The method of claim 1, wherein said calculating product recommendability is calculated using a predefined algorithm.

9. The method of claim 1, wherein said at least one product recommended is a first plurality of products recommended and said user refines said criteria, causing a second plurality of products or one product to be recommended.

10. The method of claim 3, wherein said user is provided with at least a part of at least one expert review associated with said at least one product recommendation.

11. The method of claim 1, wherein said opinion-based criteria comprise cost of operation.

12. A device for providing a recommendation of at least one product, said device configured to:
store information related to a plurality of products in a category, wherein at least one product is associated with at least one rating, and said rating comprises a rating of a plurality of criteria, and said plurality of criteria comprises opinion-based criteria;
calculate product recommendability of said plurality of products based on a selection by at least one user of an importance level of a plurality of criteria; and
recommend at least one product within said category to a user, based on said selection and said opinion-based criteria.

13. The device of claim 12, wherein said criteria further comprise functionality-based criteria of said product.

14. The device of claim 12, wherein said at least one rating comprises a plurality of ratings, and each rating of said plurality of ratings is provided by an expert.

15. The device of claim 12, wherein said plurality of criteria comprises a plurality of sub-criteria.

16. The device of claim 15, wherein said sub-criteria comprise at least a first sub-criterion with a first weighting and at least a second sub-criterion with a second-weighting.

17. The device of claim 12, wherein said selection by said at least one user comprises a selection by a plurality of users and said step of calculating product recommendability is based on an average selection of said plurality of users.

18. The device of claim 12, wherein said selection by at least one user is a selection by one user, and said product recommendation is provided to said one user.

19. The device of claim 12, wherein said calculating product recommendability is calculated using a predefined algorithm.

20. The device of claim 12, wherein said at least one product recommended is a first plurality of products recommended, and said device is configured to accept a refinement of criteria, causing a second plurality of products or one product to be recommended.

21. The device of claim 14, wherein said user is provided with at least a part of an expert review associated with said at least one product recommendation.

22. The device of claim 12, wherein said opinion-based criteria comprise cost of operation.

23. The device of claim 12, wherein said device comprises a computer readable storage medium.
